(19) United States
(12) Patent Application Publication
(10) Pub. No.: US 2023/0288244 A1
(43) Pub. Date: Sep. 14, 2023

(54) VIBRATING LEVEL SENSOR WITH ACCELERATION DETECTOR

(71) Applicant: VEGA Grieshaber KG, Wolfach (DE)

(72) Inventors: Levin DIETERLE, Oberwolfach (DE); Joerg BOERSIG, Oberwolfach (DE)

(73) Assignee: VEGA Grieshaber KG, Wolfach (DE)

(21) Appl. No.: 18/182,929

(22) Filed: Mar. 13, 2023

(30) Foreign Application Priority Data
Mar. 14, 2022 (DE) 10 2022 105 918.9

(51) Int. Cl. G01F 23/296

(52) U.S. Cl. CPC G01F 23/296

(57) ABSTRACT

A vibrating level sensor is provided, including: a mechanically vibrating system configured to sense a medium; an actuator configured to excite the mechanically vibrating system; and an acceleration detector configured to sense vibrations of the mechanically vibrating system.

### CROSS-REFERENCE TO RELATED APPLICATIONS

This application claims the benefit of priority under 35 U.S.C. § 119 from German Patent Application No. 10 2022 105 918.9, filed on 14 Mar. 2022, the entire content of which is incorporated herein by reference.

### BACKGROUND

Manufacturing processes for processing raw materials, such as mixing, heating, etc. in batch processes are usually monitored with industrial sensors that determine process characteristics such as pressure, flow, or level.

Vibrating level switches are used for sensing fill levels or limit levels for flowable media, in particular, especially for liquids or bulk solids. The vibrating level switches are in contact or not with a medium depending on a level in the vessel, so that a vibration frequency/damping or vibration amplitude of the diaphragm or the mechanical oscillator arranged on the diaphragm is influenced by the contact with the medium.

### SUMMARY OF THE INVENTION

Vibrating level sensors, or vibration level sensors, which detect a medium by means of a de-tuning of a vibrating system, typically have separate piezo systems for excitation and for evaluation of the vibrating system, or, if a single piezo system is used, are divided accordingly into, in particular differently polarized piezoelectric, sectors to enable separate excitation and evaluation of the vibrating system. Such systems can be mechanically coupled by means of an adhesive connection to the vibrating system, which can have a vibrating element for interaction with a medium. When interacting with the medium, the vibrating system can be de-tuned by means of to a tuning fork, by interaction with the medium, to detect the medium. Alternatively, electromagnetic systems can be used for excitation and detection of the oscillating system. For effective excitation of the oscillating system, it is advantageous to use a piezo system that has as large a drive area, respectively as small a sectoring, as possible.

According to an aspect of the invention, a vibrating level sensor according to the features of the independent claim is proposed. Advantageous embodiments are the subject of the dependent claims and the following specification.

Throughout this specification of the invention, some features are provided with numeral words to improve readability or to make the association clearer, but this does not imply a presence of particular features.

### BRIEF DESCRIPTION OF THE FIGURES

Embodiments of the invention are illustrated with reference to FIGS. 1 to 3, in which:

FIG. 1 is a schematic sketch of a cross-section of a vibrating level sensor;

FIG. 2 is a schematic sketch of a cross-section of a vibrating level sensor with a leg; and

FIG. 3 is a schematic sketch of a cross-section of a vibrating level sensor with a leg and support rod.

### DETAILED DESCRIPTION

According to an aspect of the invention, a vibrating level sensor is proposed that includes a mechanically vibrating system for sensing a medium. For excitation of the mechanically vibrating system, the vibrating level sensor comprises an actuator, and for sensing vibrations of the mechanically vibrating system, the vibrating level sensor comprises an acceleration detector.

In this regard, the actuator can be mechanically coupled to the mechanically vibrating system. The mechanically vibrating system can have vibrating elements, and the vibrating level sensor can be set up such that the vibrating elements can interact with the medium to change the frequency and/or amplitude and/or damping of the mechanically vibrating system by interaction with the medium. The acceleration detector can be mechanically coupled to the vibrating system, in particular to a diaphragm and/or to the actuator of the vibrating system, to detect vibrations of the mechanically vibrating system. Electrical signals generated by the acceleration detector can be provided to an evaluation unit to generate a signal by the evaluation unit that is subject to the interaction of the mechanical oscillating system with the medium.

The diaphragm of the mechanical vibration system can be mechanically coupled directly adjacent to the actuator of the mechanical vibration system.

Such a vibrating level sensor can be used, for example, to detect and/or monitor a level of a medium in a vessel. For this purpose, the vibrating level sensor, according to a level sensor, can comprise a mechanically vibrating system and a system for excitation of the mechanically vibrating system, or an actuator, and a system for sensing vibrations of the vibrating system, for example an acceleration detector. The vibrating level sensor can be mounted, e.g., on a vessel, in such a way that the mechanically vibrating system is contacting the medium when the latter reaches a predetermined filling level. By means of a system for excitation of the mechanically vibrating system, for example the evaluation unit, the mechanically vibrating system can be excited to low-frequency vibration, in particular by means of a low-frequency excitation circuit, the detected vibrations being detected by means of the evaluation unit in terms of a change in frequency and/or change in amplitude an interaction of the vibrating system with the medium.

For excitation of the mechanically vibrating system, piezoelectric actuators can be mechanically coupled to a diaphragm that can be excited to vibrate, and the piezoelectric actuators can be controlled by means of an electronic circuit to cause the mechanically vibrating system to vibrate.

Depending on a level of coverage of the mechanical oscillating system with a medium, such as a filling material, and depending on a viscosity of this medium, a change in an oscillation of the mechanically oscillating system with respect to a characteristic frequency and/or a magnitude of an amplitude can be detected by the acceleration detector. Measurement signals generated by the acceleration detector, based on the oscillations of the oscillating system, can detect a strength of such an interaction by means of the evaluation unit.

An actuator for excitation of the mechanical oscillating system can be based on both a piezoelectric operating principle as well as an electromechanical operating principle.

The acceleration detector for sensing vibrations of the mechanical oscillating system can in particular be mechanically coupled to the diaphragm such that vibrations of the diaphragm are transmitted to the acceleration detector to detect vibrations of the diaphragm. In this regard, the acceleration detector can be constructed according to a micro-electro-mechanical system (MEMS), and in particular detect accelerations based on capacitance changes between electrodes arranged in a spring-mass system. In this regard, the acceleration detector can be set up to detect angular velocities and/or rotation rates, corresponding to a gyroscope.

Advantageously, by using such an acceleration sensor, the sensing of vibrations of the mechanical oscillating system can be realized economically.

The mechanically vibrating system can have a diaphragm that is coupled, in particular mechanically vibration-capable, to the vibrating level sensor and/or a housing of the vibrating level sensor. In particular, the mechanically vibrating system can comprise a vibrating element, or vibrating member, that is mechanically coupled to the diaphragm such that vibrations of the diaphragm are transmitted to the vibrating element. In this regard, the vibrating element can comprise several sub-elements, in particular two sub-elements, which are coupled and arranged with the diaphragm in such a way that the sub-elements can interact with the medium to be detected.

Advantageously, the vibrating level sensor can comprise an actuator, such as in particular a piezo element, which can use the entire surface of the diaphragm for driving the diaphragm into oscillation. By omitting the sectoring of the actuator, which is otherwise necessary for excitation and evaluation of the diaphragm vibrations, a larger sector can be used for polarization respectively for the vibration excitation of the diaphragm, in particular by means of a piezoelectric actuator bonded to the diaphragm, for example with a single large piezoelectric element covering the entire diaphragm area, in order to achieve a higher amplitude of the mechanical vibration system with a constant excitation voltage. In addition, such a piezoelectric element can also be produced more cost-effectively by eliminating the need for complex sectoring for polarization.

In addition, the acceleration detector of the vibrating level sensor enables improved detection of the vibrations of the mechanical oscillating system, so that the control of the actuator can be improved.

Further advantageously, by spatially separating the acceleration detector from an evaluation unit, the temperature range in which the vibrating level sensor can be used can be increased.

According to an aspect, it is proposed that the mechanically vibrating system comprises a vibration-capable diaphragm and the actuator is coupled to the diaphragm. The acceleration detector is mechanically coupled to the diaphragm and/or actuator to detect the vibrations.

In this regard, the diaphragm itself can comprise elasticity and/or be elastically mounted in order to be able to be excited to vibrations, as a whole or in partial areas of the diaphragm, by means of the actuator. The actuator can be mechanically coupled to the diaphragm by bonding or by screwing in order to excite the diaphragm to vibrate. The diaphragm can interact directly with the medium, allowing sensing of a medium. Alternatively or additionally, the diaphragm can be mechanically coupled to an extended vibrating element, such as a tuning fork with prongs, such that vibration of the diaphragm causes the vibrating element to vibrate. The vibrating element of the vibrating level sensor can be configured and arranged to interact with the medium, for example in a vessel and/or a pipe, such that a frequency and/or an amplitude of the mechanically vibrating system excited by the actuator is changed by the interaction with the medium.

According to an aspect, it is proposed that the actuator is based on a piezoelectric operating principle and/or an electromechanical operating principle, and is configured to cause the mechanically vibrating system to vibrate mechanically.

Advantageously, the vibrating level sensor can comprise both an actuator based on a piezoelectric operating principle and/or an electromechanical operating principle and thus be adapted to different operating conditions and/or operating requirements.

According to an aspect, it is proposed that the vibrating level sensor additionally comprises a piezoelectric detector and/or electromechanical detector for sensing vibrations of the mechanical vibration system.

The vibrating level sensor can advantageously detect the oscillations of the mechanical oscillating system by means of an acceleration sensor and/or a piezoelectric detector and/or an electromechanical detector. The piezoelectric detector can be a subsector of a correspondingly sectored piezo system, which is configured to determine and/or evaluate vibrations of the mechanical vibration system.

Advantageously, by sensing the vibrations of the mechanical vibration system from at least two detectors based on different operating mechanisms, a measurement reliability can be increased and/or extraneous vibrations can be detected and/or interference modes can be detected, in particular to improve the sensing of the vibrations of the mechanical vibration system. For this purpose, the measured values of the at least two detectors can be compared by means of independent evaluation methods in order to eliminate respective measurement disturbances. This can lead to significantly increased measurement reliability overall. For example, an acceleration detector directly coupled to the actuator can be used for directly determining a movement of the actuator, such as a piezo system, in order to increase measurement reliability by means of a second, independent measurement or evaluation method, or to detect external vibrations.

External vibrations can be vibrations of the mechanically oscillating system, which can falsify a measurement signal with which, for example, a filling level is to be determined.

In other words, the acceleration detector, which is coupled directly or indirectly mechanically to the vibrating system, can be used to control and/or monitor the vibrations of the vibrating system with a second independent system to increase a measurement reliability for the measurement signal.

Such an acceleration detector can be bonded to a surface of a flex conductor electrically coupled at least to the actuator, such as a piezoelectric system, to be directly coupled to the actuator and/or the mechanically vibrating system.

According to an aspect, it is proposed that the acceleration detector is disposed directly adjacent to the actuator by means of a layer. In particular, the actuator can be based on a piezoelectric operating principle.

For example, such a layer can be an adhesive layer that mechanically couples the acceleration detector directly adjacent to the actuator. Alternatively or additionally, the layer can comprise sub-layers, wherein one of the sub-layers is a flat flex cable used for electrical coupling to the acceleration detector and/or actuator, mechanically coupled to an adhesive layer directly adjacent to the actuator, and coupled to another adhesive layer directly adjacent to the acceleration detector. Thus, the flex cable can mechanically couple the actuator to the acceleration detector.

Advantageously, this results in a stable and simple structure. The flex cable can be arranged to be electrically and/or signal coupled to the actuator. Alternatively or additionally, the flex cable can be electrically and/or signal coupled to the acceleration detector.

According to an aspect, it is proposed that the layer is a first adhesive layer and, in particular, the layer is a portion of a flat flex cable having the first adhesive layer and a second adhesive layer.

This sub-region of the flat flex cable can be adapted to couple the flex cable electrically to a contact on a top surface of the flex cable and/or to a contact on a bottom surface of the flex cable.

According to an aspect, it is proposed that the flat flex cable is electrically and/or signal coupled to the acceleration detector and/or actuator.

Alternatively or additionally, the acceleration detector and/or actuator can be coupled to a cable of other construction comprising a plurality of independently electrically conductive connection strands, in particular electrically insulated from each other. This cable of other construction can be electrically coupled to an evaluation unit, corresponding to the flat flex cable.

According to an aspect, it is proposed that the acceleration detector is coupled to the oscillating diaphragm and/or actuator by means of a leg at a first position of the leg to arrange the acceleration detector spaced apart from the oscillating diaphragm and/or actuator.

Advantageously, the leg can provide thermal decoupling of the vibration-capable diaphragm, which can come into direct contact with the medium to be detected.

Thus, higher process temperatures are also possible when using the vibrating level sensor 100, 200 without leaving a temperature range specified by the manufacturer for the acceleration detector 120.

By placing the acceleration detector at a distance from the actuator and/or the diaphragm by means of the leg, the acceleration detector can detect lateral accelerations parallel to the vibrating diaphragm, which are due to perturbation modes of the mechanical vibration, and in particular are based on vibration nodes in the center of the diaphragm. In this regard, a vibration of the oscillating system perpendicular to the diaphragm can be considered as the main signal, and by sensing the perturbation modes, the main signal can be improved by means of the evaluation unit, by taking into account the perturbation modes.

According to an aspect, it is proposed that the leg comprises a low thermal conductivity material to protect the acceleration detector from high temperatures of the diaphragm.

According to an aspect, it is proposed that the leg, by means of electrically conductive wirings, is configured to couple the acceleration detector electrically and/or signal-wise to an evaluation unit.

Advantageously, a leg comprising electrically conductive wirings can provide a simple structure of the vibrating level sensor that is mechanically stable. For example, the conductive wirings can be located on an outer side or inside the leg.

According to an aspect, it is proposed that the leg is configured to couple the acceleration detector electrically to the evaluation unit by means of an injection molding connection device.

Advantageously, the electrically conductive wirings can be easily and stable provided by means of an injection molded interconnection device to couple the acceleration detector electrically and/or signal-wise to an evaluation unit. In particular, the electrically conductive wiring of the leg can be coupled electrically and/or mechanically to the flat flex cable to couple the acceleration detector electrically and or signally to the evaluation unit. The evaluation unit can be coupled to the flex cable electrically and/or signally.

According to an aspect, it is proposed that the leg is disposed directly adjacent to the actuator by means of a layer and the layer is a first adhesive layer and, in particular, the layer is a portion of a flat flex cable having the first adhesive layer and a second adhesive layer. The electrically conductive wiring of the leg can be coupled electrically and/or signally o the flat flex cable.

Advantageously, this structure of the vibrating level sensor provides a stable and economically advantageous solution.

According to an aspect, it is proposed that the vibrating level sensor comprises a housing and the leg is mechanically coupled to the housing of the vibrating level sensor at a second position of the leg to support the leg and/or suppress perturbation modes of the vibration system.

Such coupling of the leg at the second position to the housing can stabilize the structure of the vibrating level sensor with a leg to provide a robust structure for the vibrating level sensor. Additionally or alternatively, an appropriate mechanical coupling of the leg at the second position with the housing can achieve that mechanical perturbation modes of the vibrating system are damped and the vibration of the vibrating system to be detected is emphasized against perturbation modes. That is, thereby perturbation modes have a lower mechanical amplitude than the oscillation of the oscillating system to be detected.

Such a coupling can be achieved, for example, by, in particular 3 to 4 elastic stainless steel bars of suitable thickness, in particular 0.5 to 1.1 mm.

According to an aspect, it is proposed that the leg at the second position is mechanically coupled by means of thermally conductive support bars to dissipate heat to the housing.

An additional benefit of mechanically coupling the leg to the housing can be a dissipation of heat to the housing conducted from the diaphragm to the acceleration detector via the leg.

According to an aspect, it is proposed that the vibrating level sensor comprises an evaluation unit which is separate from the acceleration detector, which is electrically and/or signal coupled to the acceleration detector, and which is configured to detect the medium by determining a change in a frequency of the vibration and/or an amplitude of the vibration of the oscillating system.

In this regard, the evaluation unit can be configured to both evaluate the signal from the acceleration detector and thereby generate a signal that is dependent on the interaction of the oscillation system with the medium in order to detect the medium. Additionally or alternatively, the evaluation unit can be configured to provide an excitation signal for the actuator of the oscillating system, in particular corresponding to a control and/or regulation system, depending on the signal from the acceleration detector. This excitation signal can be electrically coupled to the actuator via the flex cable. The evaluation and regulation and/or control of the excitation of the piezo drive is performed by evaluating the acceleration values measured by the acceleration detector.

For example, a control of the excitation frequency can be based on a phase shift, between an excitation signal for the actuator and a mechanical response resulting from the signal of the acceleration detector. Alternatively or additionally, the signal of the acceleration detector can be evaluated by means of a Fourier transformation (FFT: Fast Fourier Transformation) of a measured time signal of the acceleration detector into a frequency domain.

Advantageously, the vibrating level sensor can be designed to be more robust, in particular with respect to thermal changes, by means of the remote evaluation unit.

According to an aspect, it is proposed that the acceleration detector is configured to detect accelerations in two dimensions or three dimensions and the evaluation unit is configured to evaluate the accelerations in two dimensions or three dimensions to identify the perturbation modes of the vibration system.

Disturbance modes, which cause a vibration node in the center of the diaphragm and thus a tilting of the leg, produce a tilting of the leg due to the mechanical lever of the leg. The acceleration detector, which is mounted on the side of the leg facing away from the diaphragm, experiences accelerations in a direction parallel to the diaphragm and/or actuator as a result of the tilting of the leg, which can be detected by a corresponding deflection of the acceleration detector. By means of the perturbation modes detected in this way, an influence of the perturbation modes, or external vibrations, can be reduced by considering them in the evaluation by means of the evaluation unit.

It is proposed to use the vibrating level sensor described above for process control.

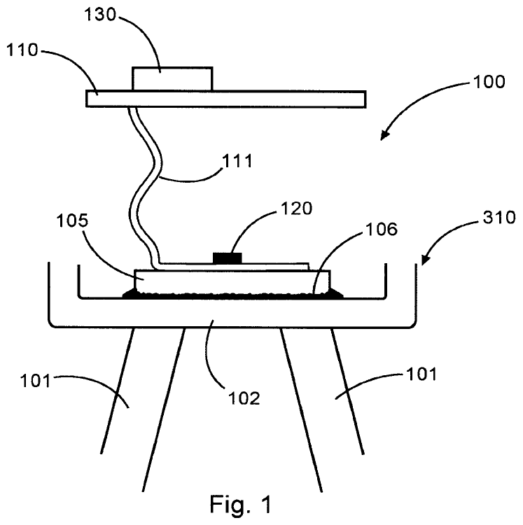

FIG. 1 schematically sketches a cross-section of a vibrating level sensor 100 with a mechanically vibrating system comprising a diaphragm 102 and a tuning fork 101 as a vibrating element, in particular with prongs in the shape of a paddle, for sensing a medium. In this regard, the vibrating element can interact with a medium to cause changes in the frequency and/or amplitude of the vibrations of the mechanically vibrating system.

The vibrating level sensor 100 further comprises an actuator 105 in the form of a piezoelectric element for excitation of the mechanical oscillating system. Further, the vibrating level sensor 100 comprises an acceleration detector 120 for sensing vibrations of the mechanical vibration system. The piezoelectric element 105 is mechanically coupled to the diaphragm 102 by means of an adhesive 106. In order to detect the medium, the vibrations of the mechanical vibration system can be detected by the acceleration detector 120, and the signals from the acceleration detector 120 can be transmitted electrically via a flex cable 111 to an evaluation unit 110, the evaluation unit 110 comprising a microprocessor 130 for evaluating the signals from the acceleration detector 120. The evaluation unit 110 is thus arranged remotely from the acceleration detector 120.

Furthermore, the piezo element as actuator 105 of the mechanical oscillating system is electrically coupled to the flex cable 111, and the evaluation unit 110 is electrically coupled to the flex cable and configured to provide electrical signals for the piezo element for oscillation excitation of the mechanical oscillating system. The signal from the acceleration detector 120 can additionally be used to control the excitation signal for the actuator 105, for example, to excite the vibrating system always at an excitation frequency, in particular its resonant frequency, regardless of the interaction with a medium.

The electrical coupling between the flex cable 111 and the actuator 105 can be provided by means of a solder connection and/or an electrically conductive adhesive connection. In other words, the flex cable 111 couples both the acceleration detector 120 and the actuator 105 to the evaluation unit 110. In this case, the acceleration detector can be arranged directly adjacent to the piezoelectric element to which it is glued or soldered to a connection area of the flex cable 111, as in FIG. 1. Alternatively, the acceleration detector 120 can also be coupled directly to the diaphragm, in particular by the acceleration detector 120 being bonded to the diaphragm 102 in order to detect the vibrations of the mechanical oscillation system.

A power supply for the acceleration detector 120 can be provided by the evaluation unit via the flex cable 111.

In this regard, the evaluation unit 110 is configured to provide both the excitation signal for the actuator, in particular controlled with a, in particular digital, signal from the acceleration detector 120, and an evaluation signal generated by the evaluation unit 110 by means of the signals from the acceleration detector 120, in particular by means of a microprocessor 130, wherein the evaluation signal represents information about the detection of a medium with the vibrating system.

In this regard, the actuator of the vibrating level sensor can be coupled to the diaphragm 102 by means of an adhesive layer 106.

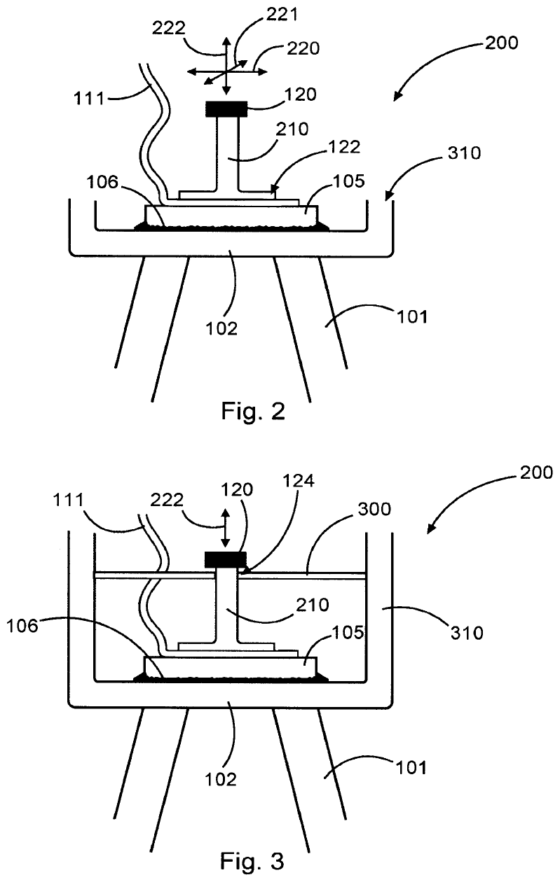

FIG. 2 schematically sketches a cross-sectional view of a vibrating level sensor 200 that is mostly similar to the vibrating level sensor 100 described above, but with the acceleration detector 120 coupled to the vibrating diaphragm 102 and/or actuator 106 at a first position of the leg 122 by means of a leg 210 to place the acceleration detector 120 spaced apart from the vibrating diaphragm 102 and/or actuator 105. In this regard, the leg at the first position 122 can be directly coupled to the actuator 105 mechanically, for example by an adhesive bond.

Furthermore, the arrows 220, 221, and 222 in FIG. 2 indicate the spatial directions in which the acceleration detector 120 can be moved. The acceleration detector 120 can be set up to detect all these three spatial directions and to provide corresponding independent signals for the evaluation unit 110, for example, by means of the flexible cable 111.

By means of the leg 210, the acceleration detector 120 can be thermally decoupled from the actuator 105 and/or the diaphragm 102. To further improve thermal decoupling, the leg 210 can comprise a material that has low thermal conductivity.

Thus, higher process temperatures are possible when using the vibrating level sensor 100, 200 without leaving a temperature range specified by the manufacturer for the acceleration detector 120.

By locating the acceleration detector 120 at a distance from the actuator 105 and/or diaphragm 102 by means of the leg 210, the acceleration detector 120 can detect lateral accelerations X, Y, 220, 221 parallel to the vibrating diaphragm 102 that are due to perturbation modes of mechanical vibration, and in particular are based on vibration nodes at the center of the diaphragm. In this regard, an oscillation Z, 222 of the oscillation system perpendicular to the diaphragm 102 can be considered as the main signal and by sensing the perturbation modes, the main signal can be improved by means of the evaluation unit 110, by taking into account the perturbation modes.

FIG. 3 schematically sketches a cross-section of a vibrating level sensor 200, which corresponds to the vibrating level sensor 200 described in FIG. 2, but in which, in addition, the leg 210 is mechanically coupled to a housing 310 of the vibrating level sensor 200 at a second position of the leg 124, in order to support the leg 210 and/or to suppress perturbation modes of the vibrating system. By means of a lateral support 300, which mechanically couples the leg 210 at the second position with the housing 310 or the housing wall, respectively, occurring perturbation modes, of the oscillation of the oscillation system, which would result in a lateral deflection of the acceleration detector, can be suppressed or damped. Such a lateral support 300 can be realized, for example, by a number of elastic and/or elastically coupled wires.

In the present embodiments, only bonded piezoelectric actuators with a piezoelectric element are outlined to improve the illustration. The vibrating level sensor can comprise alternatively or additionally screwed piezoelectric actuators or also inductive actuators whose vibration state can be evaluated by means of an acceleration detector spatially separated from the evaluation unit.

1. A vibrating level sensor, comprising:
a mechanically vibrating system configured to sense a medium;
an actuator configured to excite the mechanically vibrating system; and
an acceleration detector configured to sense vibrations of the mechanically vibrating system.

2. The vibrating level sensor according to claim 1,
wherein the mechanically vibrating system comprises a diaphragm configured to vibrate,
wherein the actuator is coupled to the diaphragm, and
wherein the acceleration detector is mechanically coupled to at least one of the diaphragm and the actuator to detect vibrations.

3. The vibrating level sensor according to claim 1, wherein the actuator is piezoelectric and/or electromechanical, and is further configured to cause the mechanically vibrating system to vibrate mechanically.

4. The vibrating level sensor according to claim 1, further comprising:
a piezoelectric detector and/or an electromechanical detector configured to sense vibrations of the mechanically vibrating system.

5. The vibrating level sensor according to claim 2, wherein the acceleration detector is arranged by means of a layer directly adjacent to the actuator and/or directly adjacent to the vibrating diaphragm.

6. The vibrating level sensor according to claim 5, wherein the layer is a first adhesive layer.

7. The vibrating level sensor according to claim 6, wherein the layer is a portion of a flat flex cable having the first adhesive layer and a second adhesive layer.

8. The vibrating level sensor according to claim 7, wherein the flat flex cable is electrically and/or signal coupled to the acceleration detector and/or the actuator.

9. The vibrating level sensor according to claim 1, wherein the acceleration detector is coupled by means of a leg to the vibrating diaphragm and/or actuator at a first position of the leg to place the acceleration detector spaced apart from the vibrating diaphragm and/or the actuator.

10. The vibrating level sensor according to claim 9, wherein the leg comprises a material of low thermal conductivity to protect the acceleration sensor from high temperatures of the diaphragm.

11. The vibrating level sensor according to claim 9, wherein the leg, by means of electrically conductive wirings, is configured to couple the acceleration detector electrically and/or signal-wise to an evaluation unit.

12. The vibrating level sensor according to claim 11, wherein the leg is further configured to electrically couple the acceleration detector to the evaluation unit by means of an injection molding connection device.

13. The vibrating level sensor according to claim 9,
further comprising a housing,
wherein the leg is mechanically coupled to the housing at a second position of the leg to support the leg and/or suppress disturbance modes of the mechanically vibrating system.

14. The vibrating level sensor according to claim 13, wherein the leg is mechanically coupled at the second position by means of thermally conductive support rods to dissipate heat to the housing.

15. The vibrating level sensor according to claim 1, further comprising an evaluation unit that is remote from the acceleration detector, is electrically and/or signally coupled to the acceleration detector, and is configured to detect the medium by determining a change in a frequency of the vibration and/or an amplitude of the vibration of the mechanically vibrating system.

16. The vibrating level sensor according to claim 15,
wherein the acceleration detector is further configured to detect accelerations in two dimensions or three dimensions, and
wherein the evaluation unit is further configured to evaluate the accelerations in two dimensions or three dimensions to identify disturbance modes of the mechanically vibrating system.
